(19) United States
(12) Patent Application Publication
(10) Pub. No.: US 2010/0052222 A1
(43) Pub. Date: Mar. 4, 2010

(54) METHOD AND DEVICE FOR CREATING THREE-DIMENSIONAL HOLLOW OBJECTS FROM RADIATION CURABLE RESIN

(76) Inventors: Andrew Kimmel, Ithaca, NY (US); Andrew Scirri, Ithaca, NY (US)

Correspondence Address: WELSH & FLAXMAN LLC, 2000 DUKE STREET, SUITE 100, ALEXANDRIA, VA, 22314, US

(21) Appl. No.: 12/549,978

(22) Filed: Aug. 28, 2009

Related U.S. Application Data
(60) Provisional application No. 61/092,449, filed on Aug. 28, 2008.

(51) Int. Cl. B29C 35/08

(52) U.S. Cl. 264/401; 425/174.4

(57) ABSTRACT

A device for forming hollow three-dimensional objects from radiation curable resin includes a light container having an interlocking base and a pivotal lid with cooperating interior surfaces forming a light chamber. An interior surface of the pivotal lid has a light source attached thereto directing light toward an interior surface of the interlocking base. A multi-axis rotating mechanism, such as a gyroscope, is positioned within the light container, the gyroscope having moving rings. A translucent three-dimensional mold capsule is removably secured to the multi-axis rotating mechanism, wherein a radiation curable resin is inserted in to the mold capsule. The associated method includes providing a translucent mold capsule with a hollow interior chamber; filling the translucent mold capsule with an amount of radiation curable resin sufficient to coat an interior surface of the hollow interior chamber of the translucent mold capsule; sealing the translucent mold capsule to contain the radiation curable resin within the hollow interior chamber; inserting and attaching the translucent mold capsule into a multi-axis rotating mechanism; positioning the multi-axis rotating mechanism within a light container having an interlocking base and lid and light source; activating the light source; setting the multi-axis rotating mechanism in motion for a period of time; removing the translucent mold capsule from the multi-axis rotating mechanism; and removing the hollow three-dimensional object so formed from the translucent mold capsule.

### BACKGROUND OF THE INVENTION

1. Field of the Invention

The present invention is directed to a radiation curable arts and crafts toy in the form of a device wherein three-dimensional, hollow articles are shaped with a transparent or near transparent mold using visible or near visible light curable polymers. The method uses various dispersion techniques of radiation curable polymers to coat the interior of translucent or near translucent molds and lighting arrays to form crafts, toys, figurines, building sets, floating objects, ornaments, and the like. The dispersion techniques employed include, but are not limited to, injection, gyroscopic motion, rotation, spraying, and vibration.

2. Description of the Related Art

Creating formed objects using mediums such as baked clay generally requires both an extended period of tithe and extremely high temperatures. As such, it is an adult oriented project that takes long periods of tithe not allowing children to participate on their own because of safety concerns. Children's toys such as Legos, Lincoln Logs and erector sets do not allow for the kids to be a part of the fabrication of the materials used. The ability for the children to create various three-dimensional structures would be both a unique experience and an excellent teaching tool.

In a previous application by the same assignee a kit and method for creating a three-dimensional toy that includes a battery powered light, a container filled with a light curable polymer and one or more molds into which the light curable polymer is inserted was described. The method of forming the three-dimensional toy involves obtaining a mold, dispensing a light curable polymer into the mold; and then curing the polymer by applying light in the visible or near visible range to the polymer via a battery powered light source.

The device and molding process of the previous application describes the creation of solid three-dimensional objects. In such a toy molding kit, the process of creating solid three-dimensional objects requires a large quantity of resin to fill the entire mold, making the kit prohibitively expensive. Additionally, a large quantity of resin takes more time to cure completely. This process wastes energy and time; and can cause children to lose interest. Furthermore, solid objects do not always cure completely through the thickness of the mold, causing the three-dimensional object to break.

A need exists for a device and molding process to create hollow three-dimensional objects from light curable polymers. This device should reduce the amount of resin needed to make a three-dimensional object, as well as, improve the speed and efficiency of the molding process.

### SUMMARY OF THE INVENTION

It is, therefore, an object of the present invention to provide a device and molding process of forming hollow, three-dimensional objects from radiation curable resin.

Further, this device is intended to be a component of a radiation curable arts and crafts toy kit.

Additionally, the unique process of forming hollow three-dimensional objects requires that the device and other kit components conform to the following specifications.

The device employs a fully enclosable capsule in which light curable polymer is dispersed inside of a translucent mold, then experiencing light activation either after full or partial dispersion of material about the mold surface, resulting in the formation of a three-dimensional hollow object.

The interior surface of the mold capsule should embody the form or specific design that is in accordance with the marketing strategy of the product.

The light container is composed of two interlocking parts, the base and the lid. The lid is attached to the base by a hinge and closed with a simple locking mechanism. A bed of light sources is attached to the interior of the lid, directing its energy down towards the base. Once the light container is closed, the light sources connected to either a battery source or electrical plug can be turned on to begin the light activation of the resin. The base of the light container houses a gyroscope in which a translucent mold can be attached to its inner most ring.

The gyroscope may be permanently fixed to the interior of the light container's base. The power that produces motion in its rings can be produced manually in the form of a hand crank, or electrically in the form of a motor. The inner ring of the gyroscope has four conveniently placed clips, one for each corner of a square mold capsule to attach. The diameter of the inner ring should be big enough to fit at least a 2″×2″ mold inside of it. The activation of motion and light can be triggered by the same event like an on/off switch or button.

The molds need to be made from a material that is highly translucent and does not bond with the light curable resin. Some examples would be fluoropolymers, silicon based polymers, or standard plastic candy molds. More desirably, the mold will be made from clear, rigid material with a chemical substance applied to the interior of the mold to further prevent bonding. Each mold may incorporate two mirror image plates connected by a hinge and sealed together by a simple locking mechanism.

It is another object of this invention to provide details about the process of forming hollow, three-dimensional objects from radiation curable resin.

It is a further object of the invention to provide a mold design that involves a means to introduce material into the mold such as an injection port, flange, or other attachment that allows resin to be injected into an enclosed mold.

Accordingly, after the correct amount of resin is introduced into one plate of the mold, the two plates are folded together and locked in place. The mold is then securely attached to the inner ring of the gyroscope at the base of the light container. As the gyroscope rotates the mold on three axes, the light activated resin is distributed over the interior surface of the mold. As the resin flows inside the mold, the light trapped within the light container quickly solidifies the resin, forming a hollow three-dimensional object.

It is, therefore, an object of the present invention to provide a device for forming hollow three-dimensional objects from radiation curable resin. The device includes a light container having an interlocking base and a pivotal lid with cooperating interior surfaces forming a light chamber. An interior surface of the pivotal lid has a light source attached thereto directing light toward an interior surface of the interlocking base. A multi-axis rotating mechanism, such as a gyroscope, is positioned within the light container, the gyroscope having moving rings. A translucent three-dimensional mold capsule is removably secured to the multi-axis rotating mechanism, wherein a radiation curable resin is inserted in to the mold capsule.

It is also an object of the present invention to provide a device wherein the light source is an array of LEDs

It is another object of the present invention to provide a device wherein the translucent three-dimensional mold capsule is made from a polymer that does not bond with the radiation curable resin inserted therein.

It is a further object of the present invention to provide a device wherein the translucent three-dimensional mold capsule is formed from first and second mirror image mold plates connected together to form a hollow interior chamber.

It is also an object of the present invention to provide a device wherein the multi-axis rotating mechanism is fixed to the interlocking base of the light container.

It is another object of the present invention to provide a device wherein the translucent three-dimensional mold capsule is attached to one of the moving rings of the gyroscope.

It is another object of the present invention to provide a device including a power source for the light source.

It is a further object of the present invention to provide a device including a power source for the moving rings of the gyroscope.

It is also an object of the present invention to provide a device including a switch to activate the light source when the interlocking base and the pivotal lid are interlocked.

It is another object of the present invention to provide a method of forming a hollow three-dimensional object. The method is achieved by providing a translucent mold capsule with a hollow interior chamber; filling the translucent mold capsule with an amount of radiation curable resin sufficient to coat an interior surface of the hollow interior chamber of the translucent mold capsule; sealing the translucent mold capsule to contain the radiation curable resin within the hollow interior chamber; inserting and attaching the translucent mold capsule into a multi-axis rotating mechanism, such as a gyroscope; positioning the multi-axis rotating mechanism within a light container having an interlocking base and lid and light source; activating the light source; setting the multi-axis rotating mechanism in motion for a period of time; removing the translucent mold capsule from the multi-axis rotating mechanism; and removing the hollow three-dimensional object so formed from the translucent mold capsule.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 shows an open hinged mold to be used with the present invention.

FIG. 2 shows a mold similar to that shown in FIG. 1 closed, loaded with resin and locked.

FIG. 3 shows the closed mold of FIG. 2 secured to a gyroscope.

FIG. 4 shows a partial view of the gyroscope of FIG. 3 highlighting the track therein about which a string with pull ring is wrapped.

FIG. 5 shows a light container to be used with the present invention.

FIG. 6 shows the gyroscope/mold combination placed or secured within the light container with the pull ring outside of the container.

### DESCRIPTION OF THE INVENTION

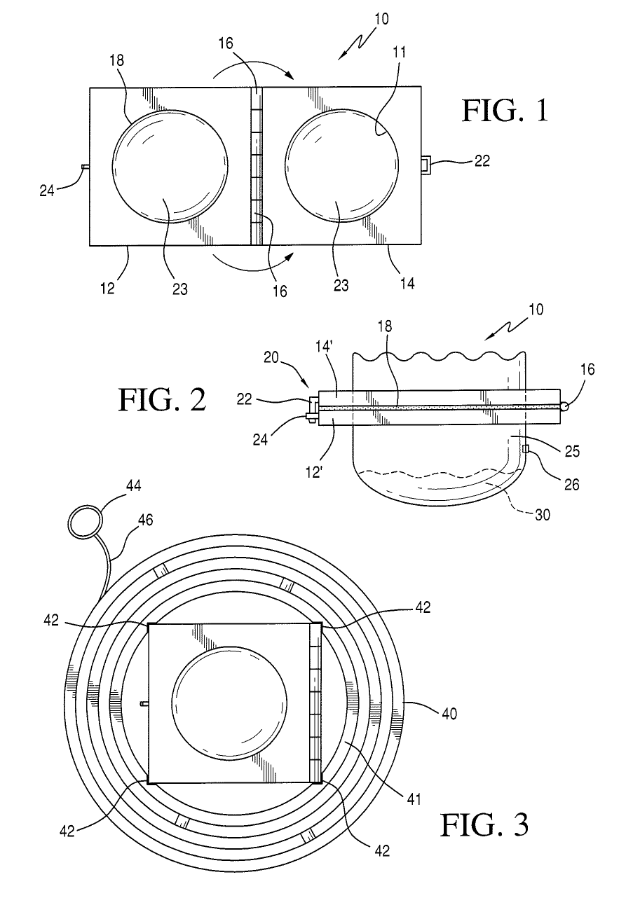

The present invention provides a device and molding process for forming hollow, three-dimensional objects from radiation curable resin. The device includes a mold such as shown in FIGS. 1 and 2 and labeled 10. The mold capsule 10 is made from a material that is highly translucent and does not bond with the radiation curable resin. Some examples would be fluoropolymers, silicon based polymers, or standard plastic candy molds. More desirably, the mold capsule 10 will be made from clear, rigid material with a chemical substance applied to the interior of the mold to further prevent bonding. Each mold capsule 10 may incorporate first and second mirror image mold plates 12, 14 connected by a hinge 16. The first and second mold plates 12′, 14′ as shown with reference to the embodiment of FIG. 2 may not be mirror images thus different shaped three-dimensional objects can be formed with different top and bottom halves. The mold plates, or halves, 12, 14 include a seal 18 therebetween. The mold plates 12, 14, in conjunction with the seal 18, define a hollow interior chamber 23 defining a mold cavity 25. When in the folded and locked position as shown in FIG. 2 the seal 18 functions to make the mold cavity 25 formed by the two mold plates 12, 14 fluid tight. When in this position, locking mechanism 20 is employed to secure and seal the mold plates 12, 14 together such that resin 30 loaded in the mold cavity 25 formed by the mold plates 12, 14 cannot escape. The locking mechanism is formed from a latch 22 on either mold plate 12′, 14′ and a post 24 on the opposite plate.

Once folded and locked together a fully enclosable mold capsules results, in which light curable polymer 30 is dispersed, then experiencing light activation either after full or partial dispersion of material about the interior surface 11 of the mold capsule 10, resulting in the formation of a three-dimensional hollow object.

The interior surface 11 of the mold capsule 10 should embody the form or specific design that is in accordance with the marketing strategy of the product. The exterior of the mold capsule 10 is dimensioned to fit within a multi-axis rotating mechanism for example a gyroscope 40 as shown in FIG. 3 for multi-axis rotation of the mold capsule 10 as discussed below in greater detail. The moving inner ring 41 of the gyroscope 40 has four conveniently placed clips 42, one for each corner of a square mold capsule 10 to attach. The diameter of the inner ring 41 needs to be big enough to fit at least a 2″×2″ mold capsule therein.

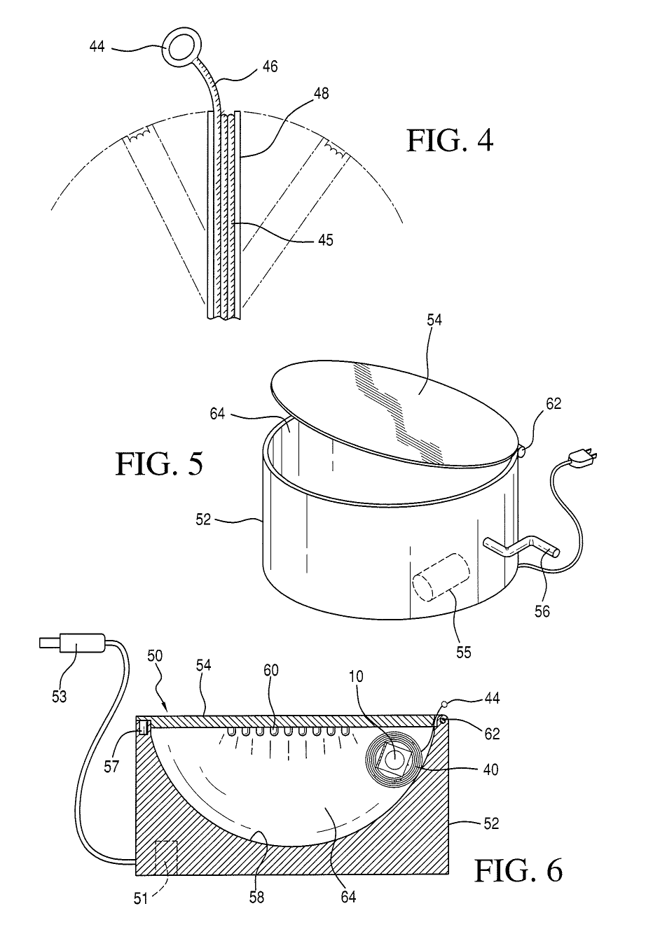

The gyroscope 40 may be permanently fixed to the interior of a light container 50. The light container 50 includes an interlocking base 52 and a pivotal lid 54 with cooperating surfaces defining the interior of the light chamber 64. In particular, the gyroscope 40 may be secured to the interlocking base 52 of light container 50. The power that produces motion in the moving rings 41, 48 of the gyroscope 40 can be produced manually in the form of a hand crank which cooperates with a drive system within the light container base 52, or electrically in the form of a motor 55 (shown in broken lines as it would be contained within interlocking base 52) which cooperates with a drive system within the interlocking base 52 of the light container 50. If automated, the activation of motion of the gyroscope 40 and turning on of the light can be triggered by an on/off switch 57 and powered by batteries 51 or AC current via electrical plug 53. Still further, the gyroscope 40 may be set into motion to freely rotate within the light container 50 when one manually pulls on pull ring 44 and unwinds string 46 from the moving rings 41, 48 of the gyroscope 40. As shown in FIG. 4, the string 46 is wrapped about a track 45 formed in the moving outer ring 48 of the gyroscope 40.

The interior surface 58 of the light container 50 could further be lined with a highly reflective material to minimize the amount of light absorbed by the light container 50 itself. The light container 50 is comprised of two interlocking parts, the interlocking base 52 and the pivotal lid 54. The pivotal lid 54 is attached to the interlocking base 52 by a hinge 62 and closed with a simple locking mechanism. A bed (or array) of lights 60 is attached to the interior surface of the pivotal lid 54, directing its energy down towards the interior surface 58 of interlocking base 52. In accordance with a preferred embodiment, it is contemplated the lights may be bulbs or LEDs. Activation of the lights 60 is controlled by a switch 57. Once the light container 50 is closed, the lights 60 connected to either the battery source 51 or electrical plug 53 can be turned on to begin the light activation of the resin. The interlocking base 52 of the light container 50 as discussed above houses the gyroscope 40 in which the translucent mold capsule 10 can be attached to its inner ring 41.

The process of forming hollow, three-dimensional objects from radiation curable resin involves a means to introduce material into the mold capsule 10, such as, via an injection port 26, flange, or other attachment that allows resin to be injected into an closed mold capsule 10 or the resin can be placed in the mold cavity 25 and then the mold plates 12, 14 closed to form the closed mold capsule 10.

Accordingly, after the correct amount of resin 30 is introduced into one mold plate 12, 14 of the mold capsule 10, the two mold plates 12, 14 are folded together and locked in place. The mold capsule 10 is then securely attached to the inner ring 41 of the gyroscope 40. As the gyroscope 40 rotates the mold capsule 10 on three axes, the light activated resin is distributed over the interior surface 11 of the mold capsule 10. As the resin flows inside the mold capsule 10, the light trapped within the light container 50 quickly solidifies the resin 30, forming a hollow three-dimensional object.

The present invention utilizes light activated radiation-curable, polymeric composition, such as an ultraviolet-curable formulation of an unsaturated resin, a monomer and a photo initiator, and a viscosity modifier and a filler. The radiation-curable compositions employed in the invention are preferably those photo-curable acrylate Systems which comprise in combination an unsaturated resin or polymer, a multifunctional cross-linking diluent and a small amount of a photo initiator, and optionally other additives, such as synergistic or small amounts of photo synergists, reactive and nonreactive oligomers, and when desired, stabilizers, antioxidants, dyes, pigments, fillers, and the like.

The visible or near visible light curable unsaturated resins employed in the present formulation may be composed of a variety of materials which include, but are not limited to, acrylated polyethers, acrylated polyester-based urethanes, methacrylate polyesters, acrylated epoxy resins. The multifunctional monomers are typically cross-linking di and multifunctional acrylates, such as, for example, neopentyl glycol diacrylate, hexanediol diacrylate, pentaerythritol triacrylate and trimethylolpropane triacrylate. Optionally, photo-curable formulations may include a monofunctional acrylate diluent, such as 2-ethylhexylacrylate, hydroxyethylacrylate, isodecylacrylate, methylcellosolve acrylate, cellosolve acrylate and the like. Various nonreactive additives, such as oligomers and polymers, may be employed typically in minor amounts, such as, for example, polyvinyl acetate resins.

The ultraviolet photo-curable formulations require the presence of a small initiating amount of a photo initiator, such as, for example, in acrylates the use of benzophenone, benzoinethylether or 2,2-diethoxyacetophenone. Such initiators are known to those skilled in the art, such as camphor quinone. In the preferred process as described and set forth herein, the radiation, cross-linkable, curable, polymer formulations are cross-linked employing light radiation, and particularly ultraviolet (visible or near visible light) light, to effect cross-linking and curing.

The visible or near visible light curable polymers of the present invention can be formulated in any color and mixtures of different colors can be put into or mixed in any mold. Alternatively, food coloring could be used to formulate any color, and the choice of color is only limited by the children's imagination. Once the product has been cured it can be further decorated using paints or markers which can be enclosed as part of a kit or obtained separately.

We claim:

1. A device for forming hollow three-dimensional objects from radiation curable resin comprising:
a light container having an interlocking base and a pivotal lid with cooperating interior surfaces forming a light chamber;
an interior surface of the pivotal lid having a light source attached thereto directing light toward an interior surface of the interlocking base;
a multi-axis rotating mechanism positioned within the light container;
a translucent three-dimensional mold capsule removably secured within the multi-axis rotating mechanism, wherein a radiation curable resin is inserted in to the mold capsule.

2. The device as set forth in claim 1, wherein the light source is an array of LEDs

3. The device as set forth in claim 1, wherein the translucent three-dimensional mold capsule is made from a polymer that does not bond with the radiation curable resin inserted therein.

4. The device as set forth in claim 1, wherein the translucent three-dimensional mold capsule is formed from first and second mirror image mold plates connected together to form a hollow interior chamber.

5. The device as set forth in claim 1, wherein the multi-axis rotating mechanism is a gyroscope with plural moving rings.

6. The device as set forth in claim 5, wherein the translucent three-dimensional mold capsule is attached to one of the moving rings of the gyroscope.

7. The device as set forth in claim 1, further including a power source for the light source.

8. The device as set forth in claim 1, further including a power source for the moving the rings of the multi-axis rotating mechanism.

9. The device as set forth in claim 1, further including a switch to activate the light source when the interlocking base and the pivotal lid are interlocked.

10. The device as set forth in claim 5, wherein the multi-axis rotating mechanism is fixed to the interlocking base of the light container.

11. A method of forming a hollow three-dimensional object comprising the steps of:
a) providing a translucent mold capsule with a hollow interior chamber;
b) filling the translucent mold capsule with an amount of radiation curable resin sufficient to coat an interior surface of the hollow interior chamber of the translucent mold capsule;
c) sealing the translucent mold capsule to contain the radiation curable resin within the hollow interior chamber;
d) inserting and attaching the translucent mold capsule into a multi-axis rotating mechanism;
e) positioning the multi-axis rotating mechanism within a light container having an interlocking base and lid and light source;
f) activating the light source;
g) setting the multi-axis rotating mechanism in motion for a period of time;
h) removing the translucent mold capsule from the multi-axis rotating mechanism;
i) removing the hollow three-dimensional object so formed from the translucent mold capsule.

12. The method of claim 11, wherein the multi-axis rotating mechanism is a gyroscope.
